(19) United States
(12) Patent Application Publication
(10) Pub. No.: US 2023/0177418 A1
(43) Pub. Date: Jun. 8, 2023

(54) System for Matching People Based on an Event

(71) Applicants: Christopher Jung, McLean, VA (US); Ha Young Kim, Suwanee (GA); Andy Long Vo, Manchester, NH (US); Yangdong Zhang, Shanghai (CN); Anastasiia Sviridenko, Moscow (RU)

(72) Inventors: Christopher Jung, McLean, VA (US); Ha Young Kim, Suwanee (GA); Andy Long Vo, Manchester, NH (US); Yangdong Zhang, Shanghai (CN); Anastasiia Sviridenko, Moscow (RU)

(21) Appl. No.: 18/073,948

(22) Filed: Dec. 2, 2022

Related U.S. Application Data
(60) Provisional application No. 63/285,884, filed on Dec. 3, 2021.

(51) Int. Cl. G06Q 10/0631

(52) U.S. Cl. CPC G06Q 10/06311

(57) ABSTRACT

A method of matching people using a matching server includes: extracting a member profile information of a member; receiving selection data of an event; receiving selection data of a desired location; determining whether the event will occur at the desired location in the future; receiving second selection data of the event; receiving a photo of the member; receiving adjustment data; receiving filter data containing a condition of the member that matches with one or more conditions of one or more other members; outputting display data that identifies the one or more other members; receiving selection data associated with choosing the one or more other members by the member; determining whether the one or more other members has chosen the member for matching; determining one or more matches between the member and the one or more other members; and outputting notification data.

### TECHNICAL FIELD

This invention relates generally to computer matching systems and more particularly to a match process system and method.

### BACKGROUND

Networking architectures have grown increasingly complex in communications environments. In recent years, a series of protocols and configurations have been developed in order to accommodate a diverse group of end users having various networking needs. Many of these architectures have gained significant notoriety because they can offer the benefits of automation, convenience, management, and enhanced consumer selections.

Certain network protocols may be used in order to allow an end user to conduct an online search of candidates to fill a given vacancy. These protocols may relate to job searches, person finding services, real estate searches, or event search. Many people want to attend an event but prefer to go with a friend or with a group, but there is a lack of services that can supply this demand.

For example, people having similar and/or compatible preferences should be able to match and attend an event together. However, effectively linking two participants together can prove to be a challenging endeavor.

One problem that has arisen is that matching services are limited to matching users based on dating preferences but there is no service to match based on an event. One solution to this problem is grouping all users who have indicated a preference for an event into a group page or chat system. This is problematic because it can be difficult and time consuming for users to find users or match with each other. Furthermore, the user must go through the list of all potential users and chats to progress: this inefficiency may cause users to give up on the search progress.

Another problem is that the search results of these services contain many irrelevant entities to the searcher. This costs the user of the service time and may deter them from continuing through all of the search results.

Another problem is that the large numbers of unwanted communication requests can become a nuisance to the user. Too many nuisance requests may deter the user from further use of the system. Users with the most attractive profiles ceases to use the system, the quality of the user pool deteriorates.

### SUMMARY

In one embodiment, a method for profile matching comprises receiving a plurality of user profiles, each user profile comprising traits of a respective user. It also comprises receiving a preference indication for a first user profile of the plurality of user profiles. It further comprises determining a potential match user profile of the plurality of user profiles based on the preference indication for the first user profile. The method also comprises presenting the potential match user profile to a second user.

The first user profile can match with a second user profile based on their preferences. The preferences chosen by the first user profile will be able to match with any other user profiles that contain the one of or all of the preferences chosen by the first user profile.

One embodiment provides a method of matching people using a matching server, the method comprising the steps of: extracting, by the matching server, a member profile information of a member from a storage; receiving, by the matching server, first selection data of an event associated with the member profile information; receiving, by the matching server, selection data of a desired location associated with the event; determining, by the matching server, whether the event will occur at the desired location in the future; upon determining the event will occur at the desired location in the future, receiving, by the matching server, second selection data of the event; receiving, by the matching server, a photo of the member; receiving, by the matching server, adjustment data of the member profile information based on the photo of the member; receiving, by the matching server, filter data containing a condition of the member that matches with one or more conditions of one or more other members, the condition being associated with the photo of the member, adjustment data of the member, and/or the member profile information; upon receiving the filter data, outputting, by the matching server, display data that identifies the one or more other members; receiving, by the matching server, selection data associated with choosing the one or more other members by the member, the one or more other members not being notified of the selection; determining, by the matching server, whether the one or more other members has chosen the member for matching; upon determining the one or more other members has chosen the member for matching, determining, by the matching server, one or more matches between the member and the one or more other members; outputting, by the matching server, notification data to the member and the one or more other members; and receiving and transmitting, by the matching server, communication data between the member and the one or more other members.

One embodiment provides a system comprising: one or more computer readable media storing instructions for matching people using a matching server; and one or more processors configured to execute the instructions to perform operations comprising: extracting, by the matching server, a member profile information of a member from a storage; receiving, by the matching server, first selection data of an event associated with the member profile information; receiving, by the matching server, selection data of a desired location associated with the event; determining, by the matching server, whether the event will occur at the desired location in the future; upon determining the event will occur at the desired location in the future, receiving, by the matching server, second selection data of the event; receiving, by the matching server, a photo of the member; receiving, by the matching server, adjustment data of the member profile information based on the photo of the member; receiving, by the matching server, filter data containing a condition of the member that matches with one or more conditions of one or more other members, the condition being associated with the photo of the member, adjustment data of the member, and/or the member profile information; upon receiving the filter data, outputting, by the matching server, display data that identifies the one or more other members; receiving, by the matching server, selection data associated with choosing the one or more other members by the member, the one or more other members not being notified of the selection; determining, by the matching server, whether the one or more other members has chosen the member for matching; upon determining the one or more other members has chosen the member for matching, determining, by the matching server, one or more matches between the member and the one or more other members; outputting, by the matching server, notification data to the member and the one or more other members; and receiving and transmitting, by the matching server, communication data between the member and the one or more other members.

One embodiment provides a non-transitory computer-readable medium storing instructions for matching people using a matching server, the instructions, when executed by one or more processors, causing the one or more processors to perform operations comprising: extracting, by the matching server, a member profile information of a member from a storage; receiving, by the matching server, first selection data of an event associated with the member profile information; receiving, by the matching server, selection data of a desired location associated with the event; determining, by the matching server, whether the event will occur at the desired location in the future; upon determining the event will occur at the desired location in the future, receiving, by the matching server, second selection data of the event; receiving, by the matching server, a photo of the member; receiving, by the matching server, adjustment data of the member profile information based on the photo of the member; receiving, by the matching server, filter data containing a condition of the member that matches with one or more conditions of one or more other members, the condition being associated with the photo of the member, adjustment data of the member, and/or the member profile information; upon receiving the filter data, outputting, by the matching server, display data that identifies the one or more other members; receiving, by the matching server, selection data associated with choosing the one or more other members by the member, the one or more other members not being notified of the selection; determining, by the matching server, whether the one or more other members has chosen the member for matching; upon determining the one or more other members has chosen the member for matching, determining, by the matching server, one or more matches between the member and the one or more other members; outputting, by the matching server, notification data to the member and the one or more other members; and receiving and transmitting, by the matching server, communication data between the member and the one or more other members.

### BRIEF DESCRIPTION OF THE DRAWINGS

Reference is now made to the following description taken in conjunction with the accompanying drawings, wherein like reference numbers represent like parts, and which:

FIG. 1A is an overview of one embodiment of the matching system;

FIG. 1B shows the contents of the terminal from FIG. 1A;

FIG. 1C shows the contents of the matching server from FIG. 1A;

FIG. 2 diagram depicting how the Application Program Interfaces (API) from a Ticket Service, Maps, and Music Service, Database, and User Interface (UI) interact with each other;

FIG. 3 is a diagram depicting how two platforms may be searched for a match, in accordance with a particular embodiment;

FIG. 4 is a diagram depicting the flow of how two users can interact with each other to potentially match;

FIG. 5 is a flowchart depicting a method for enabling communication between two users of the matching system;

FIG. 6 is the application’s splash screen upon launch;

FIG. 7 is the application’s login screen, allowing the user to log in or create an account if they do not have one registered;

FIG. 8 is the application performing login through a third-party service to provide the application with access to permissions on obtaining their third-party service account information;

FIG. 9 shows an embodiment of the onboarding system displaying to a user the fields needed to be filled in order to build their user profile;

FIG. 10 displays an embodiment of the depiction of the user prompt to select a profile picture from their photo list during the onboarding process;

FIG. 11 is a diagram of FIG. 10 which displays the profile picture selected as it would further be shown to other users during the matching process;

FIG. 12 is a diagram of the application’s artist selection onboarding screen;

FIG. 13 is a diagram of the display from FIG. 12 depicting the user selecting some artists from the generated list that pulls from the user’s third-party service account;

FIG. 14 is a diagram of the display from FIG. 12 illustrating the user entering an input into a search text box using the keyboard and tapping the check button to submit the input value;

FIG. 15 is a diagram of the display from FIG. 12 depicting a successful search request from FIG. 14 and updating the list view to include the new artist at the bottom of the list unselected;

FIG. 16 is a diagram of the display from FIG. 12 depicting an example error from the search query, showing a bad search error, which could be the result of the user’s spelling error or that the obtained artist does not have an image or genres;

FIG. 17 is a diagram of the display from FIG. 12 depicting an example error from the search query, showing a duplicate search error, which is the result of submitting a query for an artist that is already in the list;

FIG. 18 is a diagram of the display from FIG. 12 illustrating the user performing a left swipe gesture on a list item, which is one way to remove the artist from the user interface;

FIG. 19 is a diagram of the display from FIG. 12 depicting the result of removing an artist from the user interface with the left swipe gesture from FIG. 18, where the user will be notified with a temporary message and can choose to undo the action;

FIG. 20 shows one embodiment of the event search system displaying the location the user would like to attend an event;

FIG. 21 is a diagram of the display from FIG. 20 showing the effect of searching a location;

FIG. 22 shows one embodiment of the concert selection system displaying the concerts that were filtered by the user selected artists and location;

FIG. 23 is a diagram of the display from FIG. 22 showing the effect of the tapping gesture;

FIG. 24 is a diagram of the display from FIG. 22 showing the effect of deleting concerts;

FIG. 25 is a diagram of the display from FIG. 22 showing the option to undo a deleted concert;

FIG. 26 shows one embodiment displaying to a user the profile information of a second user;

FIG. 27 is a diagram of the display from FIG. 26 showing the effect of a tapping gesture;

FIG. 28 is a diagram of the display from FIG. 26 showing the effect of a left swipe gesture;

FIG. 29 is a diagram of the display from FIG. 26 showing the effect of a right swipe gesture;

FIG. 30 shows one embodiment displaying to a user the profile information of the current user;

FIG. 31 shows one embodiment displaying to a user the preference information of the current user;

FIG. 32A is a diagram of the display from FIG. 26 showing a possible effect of changing the preference information;

FIG. 32B is a diagram of the display from FIG. 26 showing a possible effect of changing the preference information;

FIG. 33 shows one embodiment of the concert selection system displaying the previously selected concerts in the main page;

FIG. 34 is a diagram of the display of FIG. 33 showing the addition of a new concert into the concert list;

FIG. 35 is a diagram of the display of FIG. 33 showing the newly added concert at the bottom of the list;

FIG. 36 is a diagram of the display of FIG. 33 showing the gesture to delete an item;

FIG. 37 is a diagram of the display of FIG. 33 showing the tapping gesture;

FIG. 38 shows one embodiment displaying to a user the application’s artist update screen, allowing users to change artist preferences to an existing account;

FIG. 39 is a diagram of the display of FIG. 38 where the user has made an input into the search input text box to add a new artist to their preferences list;

FIG. 40 is a diagram of the display of FIG. 38 illustrating the result of a successful search request made from FIG. 39, displaying the new artist list item at the bottom of the list;

FIG. 41 is a diagram of the display of FIG. 38 illustrating the user performing a gesture on a list item to remove the artist from the user interface;

FIG. 42 is a diagram of the display of FIG. 38 depicting the result of removing an artist from the user interface with a gesture where the user will be notified with a temporary message and can choose to undo the action;

FIG. 43 shows one embodiment of the event search system displaying the location the user would like to attend an event;

FIG. 44 is a diagram of the display from FIG. 43 showing the effect of searching a location;

FIG. 45 shows one embodiment of the application’s chat list screen where the current user can start a message or continue a conversation with a matched user;

FIG. 46 shows one embodiment of a conversation with a matched user. This conversation is empty;

FIG. 47 is a diagram of the display of FIG. 46 where the current user is writing a message to send to a matched user;

FIG. 48 is a diagram of the display of FIG. 46 depicting the resulting state of the conversation after the current user sends the text message from FIG. 47;

FIG. 49 is a diagram of the display of FIG. 46 where the current user is selecting an image from the device’s photo gallery to send to a matched user;

FIG. 50 is a diagram of the display of FIG. 46 depicting the resulting state of the conversation after the current user sends the image message from FIG. 49;

FIG. 51 is a diagram of the display of FIG. 46 depicting how the matched user’s text and image messages display to the current user;

### DETAILED DESCRIPTIONS

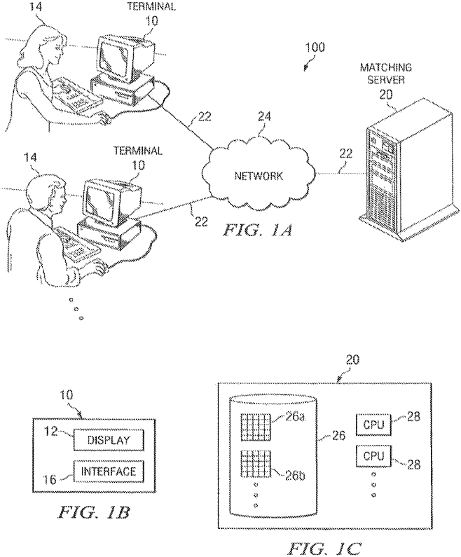

Referring to FIG. 1A, one embodiment of a matching system is shown. FIG. 1A is a simplified block diagram of a system 100 for facilitating a matching scenario in a network environment. In other embodiments, system 100 can be leveraged to identify and to evaluate suitable candidates in other areas to attend an event with. Users 14 interact with a matching server 20 through terminals 10. FIG. 1B is a diagram showing, in one embodiment, the contents of terminal 10. Terminal 10 comprises interface 16 (so that user 14 may be able to interact with terminal 10) and display 12. FIG. 1C is a diagram showing, in one embodiment, the contents of matching server 20. Matching server 20 comprises memory 26 and at least one CPU 28. Terminal 10 and matching server 20 are communicatively coupled via network connections 22 and network 24.

Users 14 are clients, customers, prospective customers, or entities wishing to participate in an online event friend matching scenario and/or to view information associated with other participants in the system. Users 14 may also seek to access or initiate communication with other users that may be delivered via network 24. Users 14 may review data (such as profiles, for example) associated with other users in order to make matching decisions or elections. Data, as used herein, refers to any type of numeric, voice, video, text, script data, or any other suitable information in any appropriate format that may be communicated from one point to another.

In one embodiment, terminal 10 represents (and is inclusive of) a personal computer that may be used to access network 24. Alternatively, terminal 10 may be representative of a cellular telephone, an electronic notebook, a laptop, a personal digital assistant (PDA), or any other suitable device (wireless or otherwise: some of which can perform web browsing), component, or element capable of accessing one or more elements within system 100. Interface 16, which may be provided in conjunction with the items listed above, may further comprise any suitable interface for a human user such as a video camera, a microphone, a keyboard, a mouse, or any other appropriate equipment according to particular configurations and arrangements. In addition, the interface may be a unique element designed specifically for communications involving system 100. Such an element may be fabricated or produced specifically for matching applications involving a user.

Display 12, in one embodiment, is a computer monitor. Alternatively, display 12 may be a projector, speaker, or another device that allows user 14 to appreciate information that system 100 transmits.

Network 24 is a communicative platform operable to exchange data or information emanating from user 14. Network 24 could be a plain old telephone system (POTS). Transmission of information emanating from the user may be assisted by management associated with matching server 20 or manually keyed into a telephone or other suitable electronic equipment. In other embodiments, network 24 could be any packet data network offering a communications interface or exchange between any two nodes in system 100. Network 24 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment, including a combination of any networks or systems described above. In various embodiments, network connections 22 may include, but are not limited to, wired and/or wireless mediums which may be provisioned with routers and firewalls.

Matching server 20 is operable to receive and to communicate information to terminal 10. In some embodiments, matching server 20 may comprise a plurality of servers or other equipment, each performing different or the same functions in order to receive and communicate information to terminal 10. Matching server 20 may include software and/or algorithms to achieve the operations for processing, communicating, delivering, gathering, uploading, maintaining, and/or generally managing data, as described herein. Alternatively, such operations and techniques may be achieved by any suitable hardware, component, device, application-specific integrated circuit (ASIC), additional software, field-programmable gate array (FPGA), server, processor, algorithm, erasable programmable ROM (EE-PROM), or any other suitable object that is operable to facilitate such operations.

In some embodiments, user 14, using terminal 10, include user 14 submitting information to matching server 20 about user 14 as well as characteristics user 14 is seeking to be matched with. Such information may include a user handle, which may be a combination of characters that uniquely identifies user 14 to matching server 20. In various embodiments, matching server 20 may be configured to collect this information; for example, matching server 20 may be configured to ask user 14 to respond to a series of questions. Matching server 20 may be configured to receive the information submitted by user 14 and create a profile for user 14 based on that information, storing the profile in a real-time database 26 that will dynamically update as information is changed.

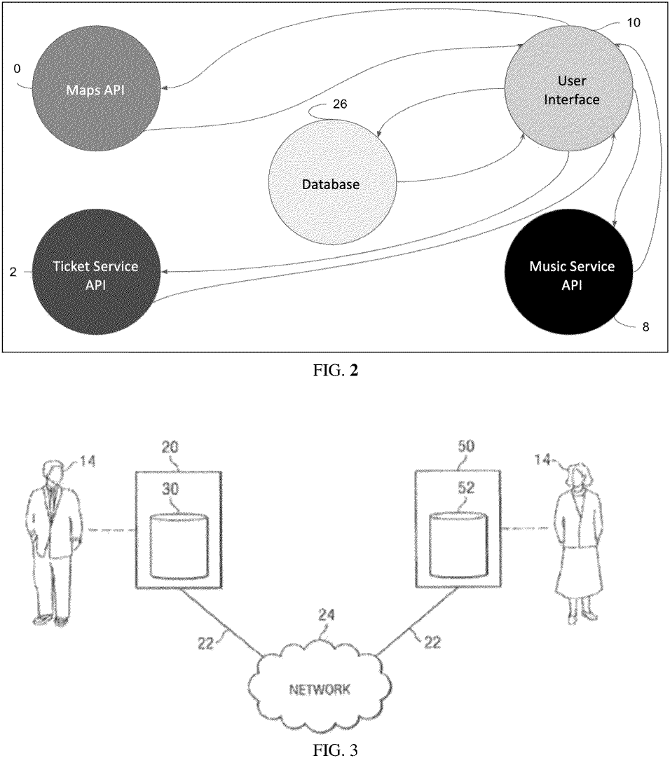

Referring to FIG. 2, an application programming interface (API) is an interface for companies and other organizations to allow third-party developers to utilize software services and data unique to the respective company or organization. These third-party developers use these interfaces to communicate with the services to streamline the exchange of data and functionality.

The user interface (UI) is the same entity as terminal 10.

Within the components 3000 used, there are three APIs used in this program including the Maps API, Music API, and Ticket Service API. Examples of possible APIs used are Google Maps API, Spotify API, and Ticketmaster Discovery API.

The Google Maps API 0 is used for its Geocoder functionality. This functionality takes in a given location and provides the coordinates of that location in longitude and latitude. The purpose of using this API is to allow the users to choose which location they would like to attend a concert. The geocoder API 0 will receive the searched location from user 14 and if the location exists within the Google Maps database, then it will retrieve and then provide the coordinates in the form of longitude and latitude.

The Spotify API 8 is used to extract the current user’s public Spotify information. To retrieve user information, Spotify OAuth 2.0 is used for authorization purposes. OAuth 2.0 is a framework that securely allows user 14 to access an application by logging in through another application. In the case of this application, user 14 logs in to Spotify to access the application. Using the OkHTTP software as the HTTP client to obtain GET requests, the purpose of the Spotify API 8 in this application is to extract information regarding the country, display name, email, unique Spotify username, as well as the top artists of user 14. Furthermore, the Spotify API is utilized to search for artists. An HTTP client is a client or service that sends out a request and retrieves responses. There are many types of HTTP requests and the Spotify API 8 uses a GET request. A GET request is used to request and retrieve data from a specified source, which in this case, is from the Spotify server. After logging in, the GET requests made by the Spotify API 8 requests for the public Spotify information of user 14. Upon retrieval of the items previously listed, the information is displayed on UI 10. User 14 can edit these items and make changes to their artist preferences before saving them and storing them into the database 26.

The Ticketmaster Discovery API 2 is used to retrieve the concerts based on the location and artists selected. Pulling artist preferences data of user 14 from the database, this information is first inserted into the Ticketmaster Discovery API 2 call, sending out a GET request for the unique artist id associated with Ticketmaster for each artist. The API request additionally takes in the latitude and longitude coordinates. If that artist corresponding to the artist id has a concert at the specified location indicated by user 14, then it will provide that data back to the application’s UI 10 in a list. From the list of concerts, the user can then select the concerts that they would like to attend from UI 10, which will then be stored in database 26.

In some embodiments, UI 10 retrieves all of the data from all three APIs which are then stored in the Database 26. A possible database example can be the Firebase Database. The Firebase Database 26 is a real-time database provided by Google. In other embodiments, UI 10 will retrieve data previously stored in database 26 and display it on terminal 10.

In FIG. 3, one embodiment is disclosed wherein matching server 20, with pool 30, may be configured to interact with another platform, such as social networking platform 50, containing a set 52 of users 14. Users 14 are communicatively coupled to matching server 20 and social networking platform 50. Matching server 20 may further be configured to provide users 14 of social networking platform 50 a service by which they may search for users 14 within set 52 or within pool 30 using the algorithms and processing of matching server 20. Matching server 20 may even further be configured to allow users 14 of matching server 20 to search through pool 30 and set 52. Matching server 20 may be configured to parse the profiles of the entities in set 52, collecting data and applying algorithms.

In another embodiment, matching server 20 may be configured to allow users 14 of social networking platform to interact with matching server 20 using social networking platform 50. This level of integration provides the advantage of users not having to learn and sign up for a different platform. Social networking platform 50, in one embodiment, may be a service that stores profiles of its users. This service may be further configured to provide access to the stored profiles. In one embodiment, social networking platform 50 may also allow other services to interact with users of social networking platform 50 through social networking platform 50.

In one embodiment, matching server 20 may be configured to collect requests from users of social networking platform 50 and perform a search through pool and set 52. Matching server 20 may further be configured to present the results of this search from within social networking platform 50. Matching server 20 may further be configured to present entities in the search result from pool 30 as if they were entities of set 52; in one embodiment, matching server 20 may be configured to generate profiles of entities from pool 30 into set 52. Thus, users of social networking platform 50 may view all of the entities in the search result, regardless of their source (either from pool 30 or set 52), within the environment of social networking platform 50.

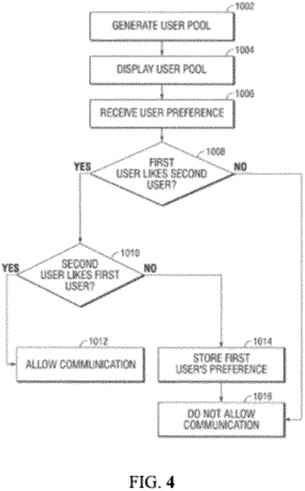

Referring to FIG. 4, At step 1002, in some embodiment, matching server 20 generates a set of user 14 profiles in response to a request for matching from a first user 14. At step 1004, matching server 20 presents the set of user 14 profiles to first user 14. Matching server 20 determines the contents and order of the set of users’ 14 profiles by using e.g., the relevance algorithms described above in the discussion of FIG. 3. For example, matching server 20 may only include user profiles whose contents indicate the location within a specified geographical radius and order the presentation of those user profiles based on the number of mutual friends in common with first user 14.

At step 1006, in some embodiments, matching server 20 receives an indication of the preference of first user 14 regarding a presented user profile. The matching server determines if first user 14 expresses approval or disapproval of the presented user profile at step 1008. If first user 14 disapproves of the presented user profile then a match is not made and, at step 1016, matching server 20 will not allow communication between the two users 14. If first user 14 expresses approval for the presented user profile at step 1008, then matching server 20 will check if second user 14 represented by the presented user profile has already expressed a preference for first user 14 at step 1010. If matching server 20 detects a mutual expression of approval then a match is made between first and second users 14. Then, at step 1012, matching server 20 allows private communications between first and second users 14. If a mutual expression of approval is not detected at step 1010, then matching server 20 stores the preference of first user 14 regarding the presented user profile for future comparison and continues to step 1016 where private communications are not yet allowed.

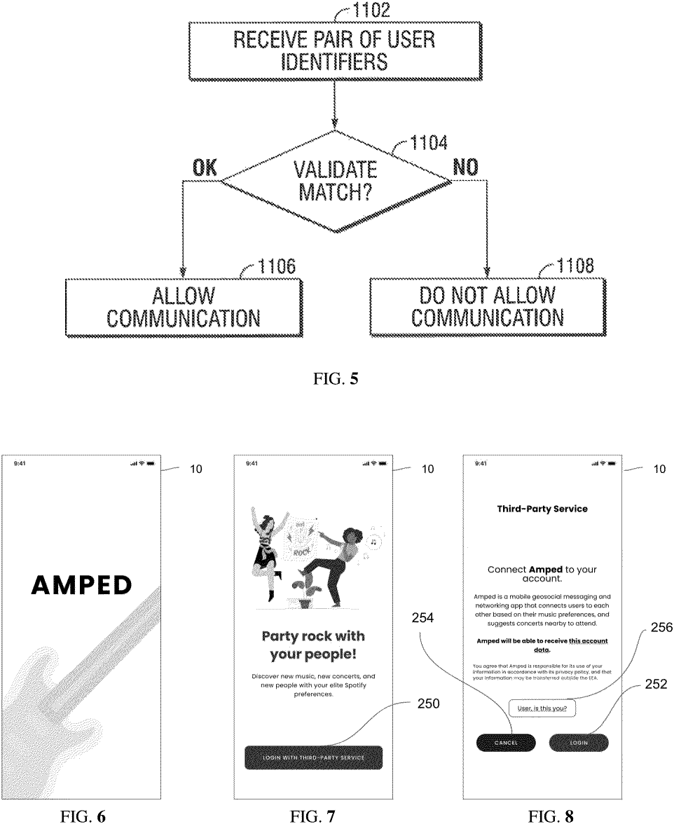

FIG. 5 is a flowchart depicting a method for enabling communication between two users 14 of the matching system of FIG. 1. If database 26 validates 1104 that there is a match between two users 14 then communication will be allowed 1106 between them. However, if database 26 does not validate 1104 that there is a match between two users 14 then communication will not be allowed 1108 between them.

FIG. 6 shows one embodiment of system 100 displaying to user 14 the application’s launch screen, which will be shown each time the current user 14 opens the application. In FIG. 6, one embodiment of this presentation is depicted through the display of terminal 10. This screen will directly flow into terminal 10 of FIG. 7.

FIG. 7 will then prompt the current user 14 with button 250 to log in using a third-party service such as Spotify. Tapping on button 250 of terminal 10 will prompt FIG. 8.

FIG. 8 depicts a third-party service’s single sign-on such as Spotify with the Spotify client to fetch the authorization code and access token for the current user 14 if the Spotify app is installed. Otherwise, there is a WebView-based authorization fallback option that opens the Spotify Accounts login page. If this is the first time user 14 is logging in on the Amped application, then the Spotify authorization will request for scopes pending user 14 approval that allows the Amped application to obtain Spotify user data. To accept the permission requests of the scopes to complete the authorization, user 14 can tap on button 254 on terminal 10 and continue with the onboarding process. Additional actions user 14 can take on terminal 10 is to decline these permissions and thereby, not log in or create an account on Amped by tapping on button 252. Doing so will bring user 14 back to FIG. 7. The third option, if the user is already logged into Spotify, is to change accounts via button 256.

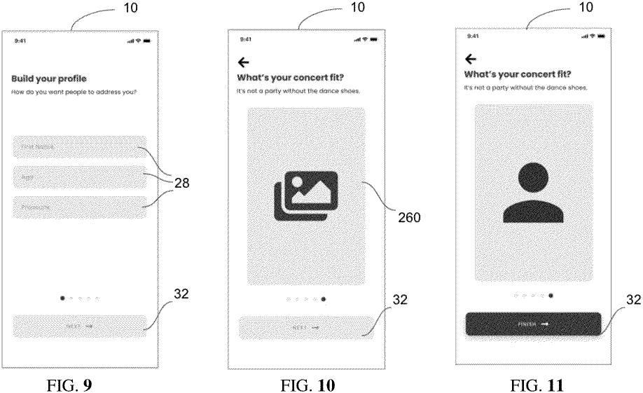

FIG. 9 is one embodiment of system 100, that shows an embodiment of the onboarding system displaying to user 14 the fields needed to be filled in order to build their user profile. User 14 submits information to matching server 20 about user 14, including 28. Once the required information has been inputted by user 14, then user 14 can tap on the “NEXT” button 32 on the screen of terminal 10. Matching server 20 may be configured to receive the information submitted by user 14 through the onboarding fields 28 and create a profile for user 14 based on that information, which then stores the profile in database 26.

FIG. 10 is one embodiment of system 100, that shows an embodiment of the depiction of the user prompt to select a profile picture from their photo list during the onboarding process. User 14 can perform a tapping gesture on the picture icon 260. The screen of terminal 10 will then display a grid of photos that are saved on terminal 10. User 14 can perform a swiping gesture to scroll through all the pictures. User 14 can then perform a tapping gesture on the photo they would like to show as the profile picture.

FIG. 11 is a diagram of the embodiment of the display from FIG. 10 showing the profile picture selected as it would further be shown to other users during the matching process. The screen of terminal 10 may display the selected picture 260 in place of the picture icon 260 pertaining to user 14. User 14 may confirm selected picture 260 by selecting the “FINISH” button 32. This will then take user 14 to the next page of the onboarding process.

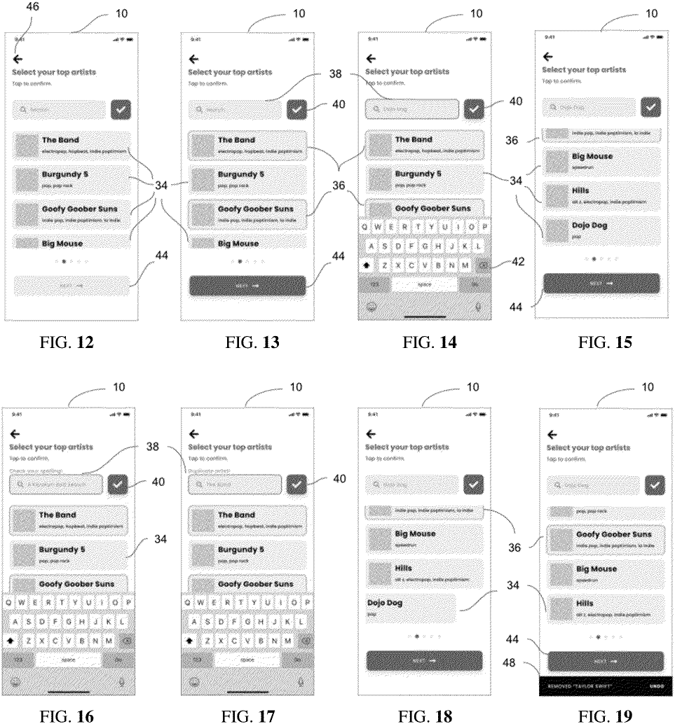

FIG. 12 shows one embodiment of system 100 displaying to user 14 the application’s artist selection onboarding screen, where user 14 will be able to select and confirm preferences for artists. One embodiment of this presentation is depicted through the display of terminal 10. In this embodiment, by allowing access to the scopes requested by the Spotify authorization from FIG. 8, the application will obtain the Spotify top artists of user 14 and terminal 10 will then display a list of artist items 34. Should user 14 want to return to the previous onboarding screen to edit user info, button 46, which indicates to go back, can be tapped on in the top left corner of terminal 10. To progress to the next onboarding screen and continue forward with the account creation button 44 can be tapped. However, button 44 is disabled, meaning it has been grayed out and is unselectable because user 14 has not selected any of the artist list items 34.

FIGS. 13, 14, 15, 16, 17, 18, and 19 are diagrams of the embodiments of the display from FIG. 12 depicting the user selecting some artists from the generated list that pulls from the user’s Spotify account (FIG. 13), illustrating the user entering an input into a search text box using the keyboard and tapping the check button to submit the input value (FIG. 14), depicting a successful search request from FIG. 14 and updating the list view to include the new artist at the bottom of the list unselected (FIG. 15), depicting an example error from the search query, showing a bad search error, which could be the result of the user’s spelling error or that the obtained artist does not have an image or genres (FIG. 16), depicting an example error from the search query, showing a duplicate search error, which is the result of submitting a query for an artist that is already in the list (FIG. 17), illustrating the user performing a left swipe gesture on a list item, which is one way to remove the artist from the user interface (FIG. 18), depicting the result of removing an artist from the user interface with the left swipe gesture from FIG. 18, where the user will be notified with a temporary message and can choose to undo the action (FIG. 19). FIG. 13 depicts a state of the artist selection onboarding screen on terminal 10 when at least one or many of the artist list items 34 have been selected. When an artist list item 34 has been selected, it becomes the active state artist list item 36, which is seen by the first and third active state artist list item 36. By having at least one active state artist list item 36, user 14 will now be able to interact with button 44 and continue to the next onboarding screen. Only selected active state artist list item 36 will be saved and added to the account’s preferences when button 44 is selected. The order of selection does not matter. If there is another artist not on the list, user 14 can tap on search box 38. Tapping on search box 38 will bring up keyboard 42 on the bottom to allow user 14 to type as illustrated on FIG. 14, which depicts the active state of typing a search entry. Once a string input is entered, user 14 can tap on check icon button 40 to submit the search query. By searching for another artist, the backend will take in current user 14’s input string and check if there are any artists using the Spotify API that exist in the Spotify system. If the input of search box 38 is empty, no search can be performed.

FIG. 15 depicts a diagram on terminal 10 with a successful search request made from FIG. 14. On a successful request, the artist that is obtained will be placed at the bottom of the list as an unselected artist list item 34. When a new artist is added, currently selected active state artist list items 36 remain in the active state when UI 10 updates.

However, not all search requests may be successful. If the artist from the search input text box 38 does not exist or the user made a spelling mistake when spelling out an existing artist and tapping check icon button 40, the request will result in an error depicted in FIG. 16. The error is located above search input text box 38 and will tell user 14 to check the spelling. Furthermore, if an artist exists and is obtained through the Spotify API call but does not have an image or genres, this will also result in an error and notify the user to check the spelling since an artist list item 34 cannot be constructed. In FIG. 17, if the search query is of an artist that is currently on the list, the search will not be conducted and the user will be notified of the duplicate artist error above search input text box 38.

In FIG. 18, user 14 in one embodiment can perform a left swiping gesture among other ways on terminal 10 on any artist list item 34 or active state artist list item 36 one at a time to remove the artist from the list. FIG. 19 displays the immediate results of removing an artist list item 34 from the list. The UI 10 will update to remove the space previously occupied by the removed artist list item 34. Additionally, a snackbar or temporary message 48 will appear at the bottom of terminal 10 to notify user 14 which artist list item 34 or active state artist list item 36 was removed. In this temporary message 48, the user can select to undo the action and “re-add” the removed item. Otherwise, user 14 may choose to ignore the message and proceed with the current list of active state artist list items 36 to the next onboarding screen using the next button 44.

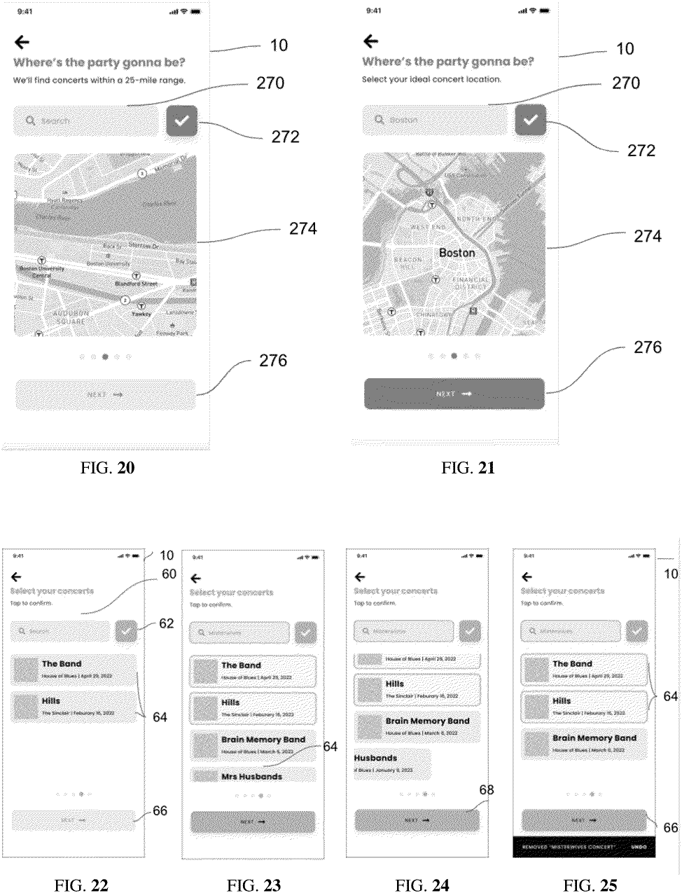

FIG. 20 shows one embodiment of system 100 displaying to user 14 the event search system displaying the location where user 14 would like to attend an event. This embodiment is depicted throughout the display of terminal 10. In this embodiment, the map 274 of the location searched by user 14 will be updated to that new location. Using terminal 10, user 14 may search a location by typing into the search text box 270 followed by tapping on the check mark button 272. The map 274 will display the search location typed into search text box 270. User 14 will then be able to view map 274 to confirm if that is the preferred location. The “NEXT” button 276 is disabled until a location is searched in the text box 270. Disabled meaning that the “NEXT” button is unable to be tapped on and can be observed as grayed out. Therefore, once a location is searched, the “NEXT” button is enabled and can be tapped on by interacting with terminal 10. In some embodiments, user 14 can perform a dragging gesture by moving a finger or other suitable object across a screen of terminal 10. Other suitable gestures or manners of interacting terminal 10 may be used (e.g., tapping on portions of a screen of terminal 10).

FIG. 21 is a diagram of embodiment of the display from FIG. 20 showing the effect of searching a location (FIG. 21). In one embodiment, by tapping on the check mark button 272, the location that user 14 has searched has now updated the map 274 to show that new location. In some embodiments, user 14 can perform a dragging gesture by moving a finger or other suitable object across a screen of terminal 10. Other suitable gestures or manners of interacting terminal 10 may be used (e.g., tapping on portions of a screen of terminal 10). This gesture gives user 14 the ability to drag around map 274 of terminal 10. However, this does not mean that the saved location searched in the text box 270 has changed. Only map 274 is changed and is displaying a different location from what was searched in the text box 270. If the displayed map 274 shows the incorrect location or user 14 would like to search a new location, then user 14 will search the new location in the text box 270 and tap on the check mark button 272 by interacting with terminal 10. Since a location has been searched, the “NEXT” button 276 is now enabled and the color has changed from being grayed out to a brightened color. Since the “NEXT” button is enabled, user 14 can save the location by tapping on the “NEXT” button 276 of terminal 10 which automatically stores the coordinates of the location in longitude and latitude in the database 26. By user 14 performing the tapping gesture on the “NEXT” button 276 a new page will display on the screen of terminal 10.

FIG. 22 shows one embodiment of system 100 showing to user 14 the concert selection system displaying the concerts that were filtered by the user selected artists and location. This is one embodiment that is depicted through the display of terminal 10. In one embodiment, user 14 may navigate through the list of concerts 64 by swiping up and down on the screen of terminal 10. In some embodiments, user 14 can perform a swiping gesture by moving a finger or other suitable object across a screen of terminal 10. Other suitable gestures or manners of interacting with terminal 10 may be used (e.g., tapping on portions of a screen of terminal 10). User 14 can also add additional concerts by searching an artist’s name in the search text box 60 followed by tapping on the check mark button 62 on the screen of terminal 10. By tapping on the check mark button 62, if the searched artist is having a concert at the chosen location then the concert will then be added to the bottom of the list. The “NEXT” button 66 is disabled until a concert 64 has been selected. Disabled meaning that the “NEXT” button is unable to be tapped on and can be observed as grayed out. Therefore, once a concert 64 is selected, the “NEXT” button is enabled and can be tapped on by interacting with terminal 10.

FIGS. 23, 24, and 25 is a diagram of the embodiment of the display from FIG. 22 showing the effect of the tapping gesture (FIG. 23), the effect of deleting concerts (FIG. 24) and the option to undo a deleted concert (FIG. 25). In some embodiments, user 14 can perform a swiping gesture by moving a finger across a screen, tapping a delete button, or perform other suitable methods to delete on terminal 10. Other suitable gestures or manners of interacting with terminal 10 may be used (e.g., tapping on portions of a screen of terminal 10). User 14 can swipe up and down and tap (on the screen of terminal 10) on the concerts 64 which then highlights the concert 64 to a brightened color to confirm that user 14 has selected the concert 64. User 14 can also deselect concerts 64 by performing a tapping gesture on the selected concert 64. When at least one concert 64 has been selected, the “NEXT” button 66 will be enabled and turned into a brightened color, which can be witnessed in FIG. 23. User 14 can delete concerts 64 from the list by swiping left or performing other suitable methods on the screen of terminal 10. This removed concert will not be in the list of concerts 64, which can be witnessed in FIG. 24. However, there is an “undo” pop-up 68 at the bottom of the screen of terminal 10. User 14 can perform a tapping gesture on the “undo” button pop-up 68 on the screen of terminal 10. Once this tapping gesture has been performed, then the concert 64 will reappear on the list as can be witnessed in FIG. 25. This “undo” button pop-up 68 appearing on the screen of terminal 10 is only temporary so if user 14 does not perform the tapping gesture on the “undo” button 68 within a short period of time then the “undo” button pop-up 68 will disappear. This means that the concert 64 is removed from the concert 64 list and will not appear on the screen of terminal 10. However, user 14 can type in the artist name in the search text box 60 then perform a tapping gesture on the check mark button 62. This will then add the concert 64 to the bottom of the concert 64 list. Once all of the concerts 64 that user 14 would like to attend have been selected, user 14 can then tap on the “NEXT” button 66 on the screen of terminal 10 which will store these selected concerts in database 26. By user 14 performing the tapping gesture on the “NEXT” button 66 a new page will display on the screen of the terminal 10.

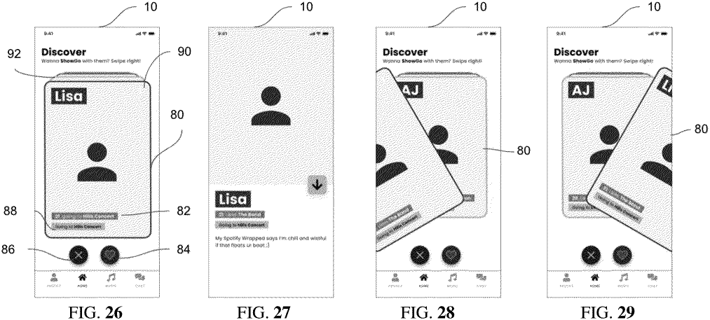

FIG. 26 shows one embodiment of system 100 displaying to a user the profile information of a second user. Matching server 20 may be configured to search through its plurality of profiles and present suggested matches to user 14. In FIG. 26, one embodiment of this presentation is depicted as occurring through the display of terminal 10. In this embodiment, a plurality of user profiles is presented to user 14. Using terminal 10 user 14 may request that matching server 20 present a subset of users from user profile pool 30 based on a specific filter parameter (FIG. 29.). The display may show an image of a suggested user and one or more aspects of the suggested user’s profile information. The combination of image and one or more aspects of profile information is displayed as a “card” 80 representing the suggested user. A set of suggested users may be displayed as a stack of cards 92. User 14 may view information regarding one suggested user at a time. The presented information may include one or more of: a picture, name, age, artist interest 82, and concert interest 88. User 14 may view further information of one suggested user using button 90. This information will be shown as displayed in FIG. 27. User 14 may express approval or disapproval for a presented user. Expressing approval or disapproval can be accomplished through various methods. For example, terminal 10 may display “like” button 84 (represented by a heart icon) and “dislike” button 86 (represented by an “X” icon). Pressing like button 84 indicates to matching server 20 that user 14 approves of and is interested in communication with the presented user. Pressing dislike button 86 indicates that user 14 disapproves of and does not have interest in communicating with the presented user. The approval preference of user 14 is anonymous in that matching server 20 does not inform users 14 whether other users have expressed approval or disapproval for them.

FIGS. 27, 28 and 29 are diagrams of the embodiments of the display from FIG. 26 showing the effect of a tapping gesture (FIG. 27) and showing the effect of a left swipe gesture (FIG. 28) and the effect of a right swipe gesture (FIG. 29). In one embodiment, users 14 may navigate through the rest of presented users by swiping through stack of cards 88. Users 14 may also express approval of a presented user by performing a right swipe gesture or express disapproval by performing a left swipe gesture. In some embodiments, user 14 performs a swiping gesture by moving a finger or other suitable object across a screen of terminal 10.

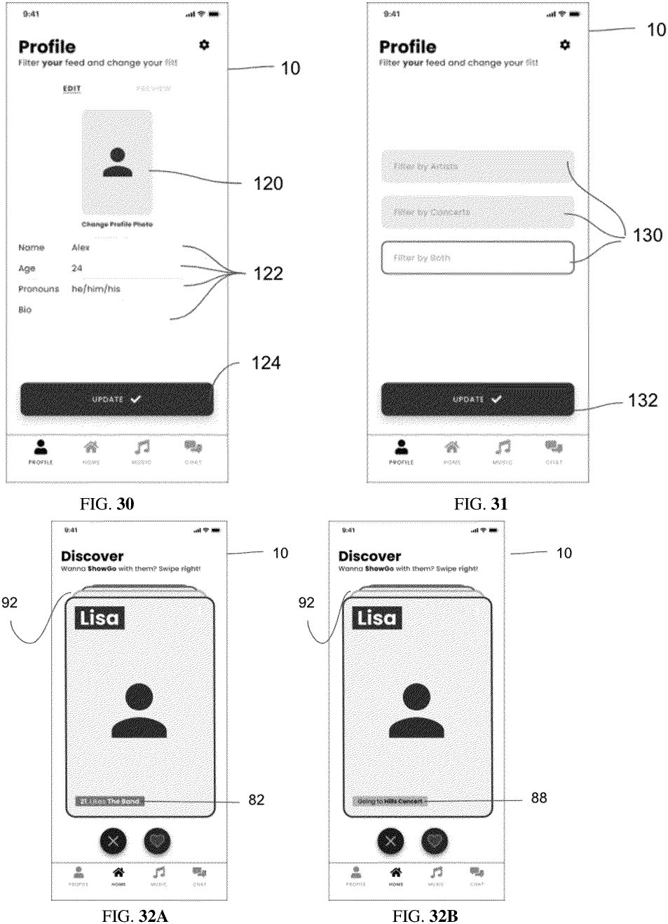

FIG. 30 shows one embodiment of system 100 displaying to a user 14 the current display information of that user. Terminal 10 may display information 120, 122 pertaining to a user 14. User 14 may edit information 120, 122 accordingly and use “update” button 124 to send the updated information to matching server 20.

FIG. 31 shows one embodiment of system 100 displaying to a user 14 the current preference information of that user. Terminal 10 may display information 130 pertaining to a user 14. A user 14 may choose to filter to be presented with certain types of users. As an example, consider a registered user John, who is filtering through users that pertain to similarities in both concert interest 88 and artist interest 82. The matching server 20 will retrieve and display cards 92 containing both interests 82, 88. John may then choose to request matching server 20 to solely present users that have a similar interest in artists. Matching server 20 will retrieve and display cards 92 displaying suggested users with similar interest 82 as shown in FIG. 32A. John may also choose to request matching server 20 to solely present users that have a similar interest in concerts. Matching server 20 will then retrieve and display cards 92 displaying suggested users with similar interest 88 as shown in FIG. 32B.

FIGS. 32A and 32B is a diagram of the display from FIG. 26 showing the display of the preference selection process in FIG. 31.

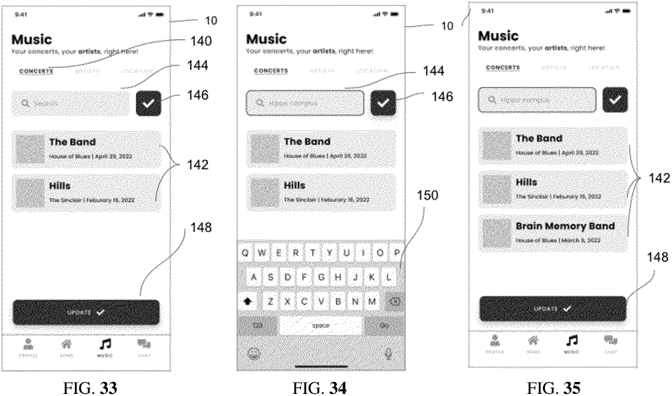

FIG. 33 shows one embodiment of system 100 showing to user 14 the concert selection system displaying the previously selected concerts in the main page on the screen of terminal 10. User 14 can use the tapping gesture and tap on the concerts tab 140 to get to this page. In some embodiments, user 14 can perform a tapping gesture by pressing their finger on the screen of terminal 10. Other suitable gestures or manners of interacting with terminal 10 may be used (e.g., swiping across the screen of terminal 10). User 14 can see the list of concerts 142 they previously selected during the onboarding page. If user 14 would like to add more concerts to the concert list 142, then user 14 can tap on the search bar 144. After user 14 has entered the artist that user 14 would like to see a concert in, user 14 will tap on the check mark button 146. Once this tapping gesture has been performed, the concert 142 will then show up at the bottom of the concert list 142. Then, user 14 can tap on the update button 148 to include the concert into database 26.

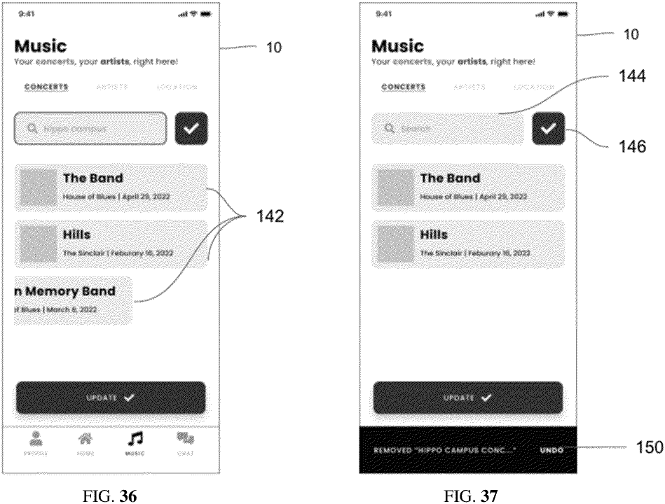

FIGS. 34, 35, 36, and 37 is a diagram of the display of FIG. 33 showing the addition of a new concert into the concert list (FIG. 34) and showing the newly added concert at the bottom of the list (FIG. 35) and showing a gesture to delete an item (FIG. 36) and showing the tapping gesture (FIG. 37). Exactly how it is displayed for the onboarding, the same is done for the main pages. User 14 can add a concert by performing a tapping gesture on the search bar 144 and entering in an artist’s name. Then user 14 will then tap on the check mark icon 146, which can be witnessed in FIG. 34. If the artist is having a concert at the saved location then it will show up at the bottom of the concert list 142, which can be witnessed in FIG. 35. In some embodiments, user 14 can delete concerts 142 from the list by swiping left or other suitable methods on the screen of terminal 10. This removed concert will not be in the list of concerts 142, which can be witnessed in FIG. 36. However, there is an “undo” pop-up 150 at the bottom of the screen of terminal 10. User 14 can perform a tapping gesture on the “undo” button pop-up 150 on the screen of terminal 10 in FIG. 37. This “undo” button pop-up 150 appearing on the screen of terminal 10 is only temporary so if user 14 does not perform the tapping gesture on the “undo” button 150 within a short period of time then the “undo” button pop-up 150 will disappear. This means that the concert 142 is removed from the concert list 142 and will not appear on the screen of terminal 10. However, user 14 can type in the artist name in the search text box 144, then perform a tapping gesture on the check mark button 146. This will then add the concert 142 to the bottom of the concert list 142. Then, user 14 can tap on the update button 148 to include the concert into database 26.

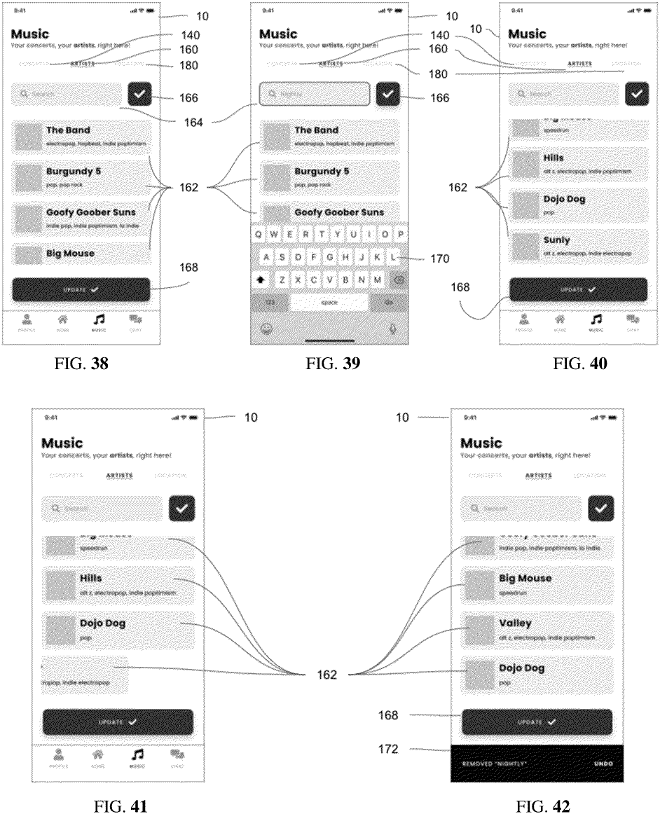

FIG. 38 shows one embodiment of system 100 displaying to user 14 the application’s artist update screen, allowing user 14 to change artist preferences to an existing account. In FIG. 38, one embodiment of this presentation is depicted through the display of terminal 10. In this embodiment, user 14 has selected the artists tab 160 of the music navigation screen. Like the concerts tab, a user can select concerts tab 140 or location tab 180, with the artists tab 160 already being highlighted given that that is the tab user 14 is currently viewing. Similar to the onboarding experience of FIGS. 8, 9, 10, 11, 12, 13, 14, and 15, user 14 can interact with the search elements and list elements. Below the concerts/artists/location tabs (140, 160, 180 respectively), user 14 can make a search request for additional artists to add to their existing account artist preferences by tapping on the search input text box 164 and submitting the request with check icon button 166. In the middle of the user interface on terminal 10, user 14 sees artist list items 162. Rather than confirming again, artist list items 162 differ from artist list items 34 in FIG. 8 by not having an active state. This is because these artist list items 162 have already been selected by the user and only need to be updated rather than confirmed. Thus, the update button with the check icon 168 that reads “UPDATE” will always be available for user 14 to tap on. All artist list items 162 displayed on the user interface will be updated to user 14’s artist preferences upon tapping update button 168.

FIGS. 39, 40, 41, and 42 are diagrams of the embodiments of the display from FIG. 38 where the user 14 has made an input into the search input text box 164 to add a new artist to their preferences list (FIG. 39), illustrating the result of a successful search request made from FIG. 39, displaying the new artist list item 162 at the bottom of the list (FIG. 40), illustrating the user 14 performing a gesture on an artist list item 162 to remove the artist from the user interface (FIG. 41), and depicting the result of removing an artist from the user interface with a gesture where the user 14 will be notified with a temporary message 172 and can choose to undo the action (FIG. 42). In FIG. 39, user 14 has typed out a new artist using keyboard 170 into search input text box 164. By tapping on the check icon button 166, the user 14 makes a Spotify API request to search for the artist from the search input text box 164. User 14 can run into a bad search error or duplicate artist error. In the former, user 14 has inputted a string of an artist that does not exist in Spotify’s system possibly due to a spelling error, or the obtained artist does not have an image or genres to successfully build a new artist list item 162. The latter, user 14 inputted an artist that currently exists in user 14’s preferences as an artist list item 162. Upon a successful search request depicted in FIG. 40, the newly added artist is added at the bottom of the list as an artist list item 162. From here, user 14 can tap on update button 168 to update the changes made to the artist preferences list in database 26.

In FIG. 41, user 14 can perform a left swiping gesture or other suitable methods on terminal 10 on any artist list item 162 one at a time to remove the artist from the list. FIG. 42 displays the immediate results of removing an artist list item 162 from the list. The user interface of terminal 10 will update to remove the space previously occupied by the removed artist list item 162. Additionally, a snackbar or temporary “UNDO” message 172 will appear at the bottom of terminal 10 to notify user 14 which artist list item 162 was removed. In this temporary message 172, the user 14 can select to undo the action and “re-add” the removed item. Otherwise, user 14 may choose to ignore the message and proceed with the current list of artist list items 162 to update preferences using update button 168 to database 26.

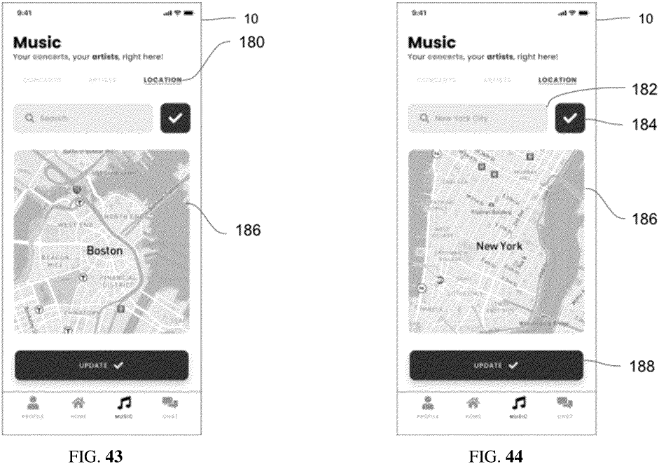

FIG. 43 shows one embodiment of system 100 showing the event search system displaying the location that user 14 would like to attend an event on the screen of terminal 10. User 14 is able to perform a tapping gesture on the “LOCATION” button 180 which will display the location page. User 14 will be able to see the map 186 of the location they previously searched in the onboarding process.

FIG. 44 is a diagram of the display from FIG. 43 showing the effect of searching a location. Although user 14 previously entered a location of where they would like to attend a concert, they can change that location on the main page. User 14 can perform a tapping gesture on the search bar 182 which will allow them to search a new location. Then user 14 can tap on the check mark button 184 which will then change the map 186 to the new location that was entered. Once user 14 verifies the location on the map 186 that the location is correct, user 14 can then tap on the update button 188 to update the new location into database 26. The location that is saved in the database 26 is saved in the form of the location’s coordinates of longitude and latitude.

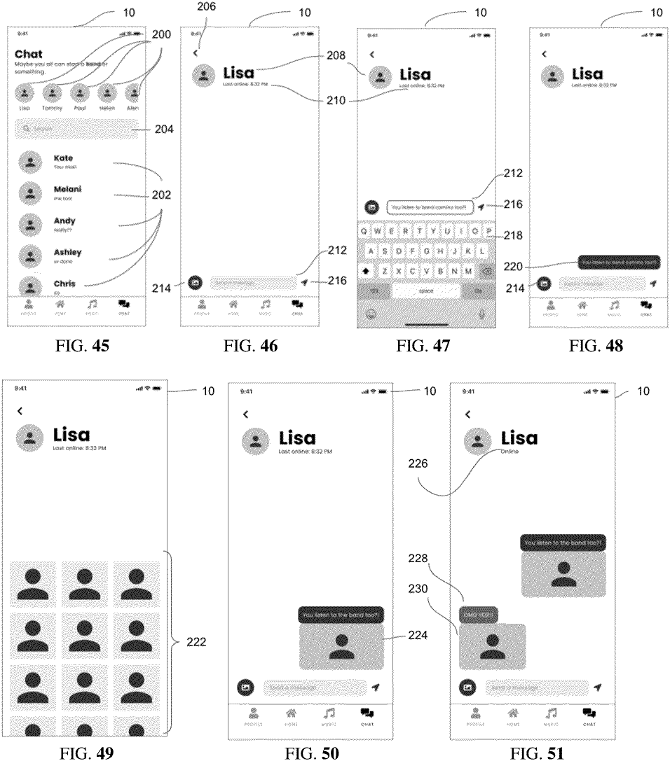

FIG. 45 shows one embodiment of system 100 displaying to user 14 the application’s chat list screen, where user 14 will be able to browse through user 14’s current list of matches and conversations with matches. In FIG. 45, one embodiment of this presentation is depicted through the display of terminal 10. In this embodiment, user 14 has not started conversations with any matches of the chat navigation screen. There are three main types of interactions user 14 can choose to perform on terminal 10. Firstly, user 14 can browse through a horizontal list of matched users 200. The horizontal list of matched users 200 will be those where user 14 or the other matched user 200 has not initiated a conversation. Thus, the conversation is empty between user 14 and the matched user 200. Below the horizontal list of matched users 200, user 14 can choose to open up an existing conversation with a matched user 202. This list can be scrolled vertically. Furthermore, user 14 can search for a matched user 200 or existing conversation 202 with the search input text box 204.

FIG. 46 shows one embodiment of system 100 displaying to user 14 the application’s chat list screen where the user 14 can start a message or continue a conversation with a matched user 200 from FIG. 45. In the display of FIG. 46, user 14 can send text and image/video messages and see the status of the matched user. The matched user 200 in conversation 208 shows their first name and profile image. Below the matched user in conversation 208, user 14 can see the online status 210 of the matched user in conversation 208. If user 14 wishes to send a text message, message input text box 212 can be tapped on to bring up a keyboard as depicted in the keyboard 218 of FIG. 47. If user 14 wishes to send an image message, image button 214 will bring up the photo gallery of user 14. After selecting an image or writing out a message, user 14 can send the message with the send message button 216. If user 14 wishes to return to the chat list screen in FIG. 45, user 14 can tap on the back button 206 to return to the chat list screen.

FIGS. 47, 48, 49, 50, and 51 are diagrams of embodiments of the display from FIG. 46 showing the different states of messaging where the current user 14 is writing a message to send to a matched user 200 (FIG. 47), depicting the resulting state of the conversation after the current user 14 sends the text message 220 from FIG. 47 (FIG. 48), where the current user 14 is selecting an image from the device’s photo gallery 222 to send to a matched user 200 (FIG. 49), depicting the resulting state of the conversation after the current user 14 sends the image message 224 from FIG. 49 (FIG. 50), and depicting how the matched user’s text and image messages 228 and 230, respectively, display to the current user 14 (FIG. 51). In terminal 10 of FIG. 47 shows the active state of writing out a text message 212 in the chat message screen of FIG. 46. User 14 can type a message with keyboard 218 and the user interface will update with the text message in the message input text box 212. Once user 14 is satisfied with the message and is ready to send, user 14 can tap on the send button 216 to send a message. In FIG. 48, user 14 can see the updated state of the chat screen. The text message written out and sent by user 14 is now displayed as a message 220 on the right-hand side. All text messages 220 sent by user 14 will appear on the right-hand side of the chat screen user interface. Now that at least one message has been sent by at least one party of the match, the matched user 200 will now appear as an existing conversation with a matched user 202 in FIG. 45.

FIG. 49 shows the state of the application in terminal 10 after user 14 has tapped on the image button 214 from FIG. 46. In FIG. 49, user 14 can select an image to send from the device’s photo gallery 222. After selecting an image and tapping the send button 216, the image will be sent into the chat screen user interface. This can be seen in the FIG. 50 diagram. All image/video messages 224 sent by user 14 will appear on the right-hand side. From the perspective of user 14, all text messages 228 and image/video messages 230 sent by the matched user 200 will appear on the left-hand side of the chat screen user interface as shown in the diagram of FIG. 51. Furthermore, if the matched user 200 is actively on the application, their status will appear as “Online” from the perspective of user 14.

What is claimed is:

1. A method of matching people using a matching server, the method comprising the steps of:
extracting, by the matching server, a member profile information of a member from a storage;
receiving, by the matching server, first selection data of an event associated with the member profile information;
receiving, by the matching server, selection data of a desired location associated with the event;
determining, by the matching server, whether the event will occur at the desired location in the future;
upon determining the event will occur at the desired location in the future, receiving, by the matching server, second selection data of the event;
receiving, by the matching server, a photo of the member;
receiving, by the matching server, adjustment data of the member profile information based on the photo of the member;
receiving, by the matching server, filter data containing a condition of the member that matches with one or more conditions of one or more other members, the condition being associated with the photo of the member, adjustment data of the member, and/or the member profile information;
upon receiving the filter data, outputting, by the matching server, display data that identifies the one or more other members;
receiving, by the matching server, selection data associated with choosing the one or more other members by the member, the one or more other members not being notified of the selection;
determining, by the matching server, whether the one or more other members has chosen the member for matching;
upon determining the one or more other members has chosen the member for matching, determining, by the matching server, one or more matches between the member and the one or more other members;
outputting, by the matching server, notification data to the member and the one or more other members; and
receiving and transmitting, by the matching server, communication data between the member and the one or more other members.

2. A system comprising:
one or more computer readable media storing instructions for matching people using a matching server; and
one or more processors configured to execute the instructions to perform operations comprising:
extracting, by the matching server, a member profile information of a member from a storage;
receiving, by the matching server, first selection data of an event associated with the member profile information;
receiving, by the matching server, selection data of a desired location associated with the event;
determining, by the matching server, whether the event will occur at the desired location in the future;
upon determining the event will occur at the desired location in the future, receiving, by the matching server, second selection data of the event;
receiving, by the matching server, a photo of the member;
receiving, by the matching server, adjustment data of the member profile information based on the photo of the member;
receiving, by the matching server, filter data containing a condition of the member that matches with one or more conditions of one or more other members, the condition being associated with the photo of the member, adjustment data of the member, and/or the member profile information;
upon receiving the filter data, outputting, by the matching server, display data that identifies the one or more other members;
receiving, by the matching server, selection data associated with choosing the one or more other members by the member, the one or more other members not being notified of the selection;
determining, by the matching server, whether the one or more other members has chosen the member for matching;
upon determining the one or more other members has chosen the member for matching, determining, by the matching server, one or more matches between the member and the one or more other members;
outputting, by the matching server, notification data to the member and the one or more other members; and
receiving and transmitting, by the matching server, communication data between the member and the one or more other members.

3. A non-transitory computer-readable medium storing instructions for matching people using a matching server, the instructions, when executed by one or more processors, causing the one or more processors to perform operations comprising:
extracting, by the matching server, a member profile information of a member from a storage;
receiving, by the matching server, first selection data of an event associated with the member profile information;
receiving, by the matching server, selection data of a desired location associated with the event;
determining, by the matching server, whether the event will occur at the desired location in the future;
upon determining the event will occur at the desired location in the future, receiving, by the matching server, second selection data of the event;
receiving, by the matching server, a photo of the member;
receiving, by the matching server, adjustment data of the member profile information based on the photo of the member;
receiving, by the matching server, filter data containing a condition of the member that matches with one or more conditions of one or more other members, the condition being associated with the photo of the member, adjustment data of the member, and/or the member profile information;
upon receiving the filter data, outputting, by the matching server, display data that identifies the one or more other members;
receiving, by the matching server, selection data associated with choosing the one or more other members by the member, the one or more other members not being notified of the selection;
determining, by the matching server, whether the one or more other members has chosen the member for matching;
upon determining the one or more other members has chosen the member for matching, determining, by the matching server, one or more matches between the member and the one or more other members;
outputting, by the matching server, notification data to the member and the one or more other members; and
receiving and transmitting, by the matching server, communication data between the member and the one or more other members.
